(19) United States
(12) Patent Application Publication
(10) Pub. No.: US 2010/0009155 A1
(43) Pub. Date: Jan. 14, 2010

(54) SEMICONDUCTOR WAFER AND PRODUCTION METHOD THEREOF

(75) Inventors: Tomohiro Hashii, Tokyo (JP); Kazushige Takaishi, Tokyo (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Sumco Corporation, Tokyo (JP)

(21) Appl. No.: 12/501,343

(22) Filed: Jul. 10, 2009

(30) Foreign Application Priority Data
Jul. 14, 2008 (JP) 2008-182963

(51) Int. Cl. B32B 5/00; B24B 1/00

(52) U.S. Cl. 428/220; 451/57

(57) ABSTRACT

It is to provide a double-side mirror-finished semiconductor wafer having an excellent flatness by conducting a polishing step from rough polishing to finish polishing for simultaneously polishing both surfaces of a raw wafer with the same polishing cloth to reduce the polishing amount of the raw wafer as well as a production method thereof.

In method of producing a semiconductor wafer, which comprises a polishing step for finish-polishing both surfaces of a raw wafer while supplying a polishing solution containing abrasives to a polishing cloth, wherein at least two polishing solutions classified by an average particle size of abrasives to be included are supplied into the polishing cloth while changing from a polishing solution containing larger size of abrasives to a polishing solution containing smaller size of abrasives in stages, whereby the polishing step from rough polishing to finish polishing is conducted on both surfaces of the raw wafer simultaneously with the same polishing cloth, whereby the flatness (GBIR) of not more than 0.1 μm is attained even in large-size semiconductor wafers having a diameter of not less than 450 mm.

### BACKGROUND OF THE INVENTION

1. Field of the Invention

This invention relates to a semiconductor wafer and a production method thereof, and more particularly to a method of producing a semiconductor wafer in which both surfaces of a raw wafer are mirror-polished.

2. Description of the Related Art

As one of performances required for the semiconductor wafer is mentioned an improvement in a surface accuracy. Particularly, the demand on the flatness of the semiconductor wafer in the light exposure becomes severer due to scale down of devices formed on the semiconductor wafer and large-diameter formation of the semiconductor wafer.

The semiconductor wafer is produced through a slicing step of cutting out a raw wafer from an ingot, a grinding step of approximating a thickness of the cut raw wafer to a given thickness and a polishing step of setting the thickness of the ground raw wafer within a given tolerance and rendering the surface of the raw wafer into given roughness and properties. In case of a double-side mirror-finished semiconductor wafer, it is required to have good surface properties on both surfaces of the semiconductor wafer, so that it is common to add a step of finish-polishing the both surfaces of the semiconductor wafer in the final production steps in addition to the above-mentioned polishing step.

For example, Patent Document 1 discloses a method of producing a semiconductor wafer in which front and back surfaces of a double-side polished raw wafer are subjected to a finish polishing with a buff at the final step while supplying a polishing solution to provide a double-side mirror-finished semiconductor wafer.

[Patent Document 1] Japanese Patent No.3109419

In the production method disclosed in Patent Document 1, however, the double-side polishing step is separated from the finish polishing step, so that it is unavoidable that the surface of the raw wafer is scratched or soiled after the double-side polishing step and the polishing amount of the raw wafer associated with the removal of scratch and contaminant is increased at the finish polishing step, and as a result, there is a problem that the flatness of the semiconductor wafer is deteriorated. Such a problem is especially remarkable in large-size semiconductor wafers having a diameter of not less than 450 mm.

### SUMMARY OF THE INVENTION

With the foregoing in mind, it is an object of the invention to provide a double-side mirror-finished semiconductor wafer having an excellent flatness by conducting a polishing step from rough polishing to finish polishing for simultaneously polishing both surfaces of a raw wafer with the same polishing cloth to reduce the polishing amount of the raw wafer as well as a production method thereof.

Particularly, the invention develops a significant effect when a semiconductor wafer is a large-size silicon wafer having a diameter of not less than 450 mm.

In order to achieve the above object, the inventors have made various studies on a method of producing a semiconductor wafer which can improve the flatness of the semiconductor wafer by reducing a polishing amount of a raw semiconductor wafer as compared with the conventional method when both surfaces of the raw wafer after the grinding are polished to form a double-side mirror-finished semiconductor wafer.

As a result, it has been found that the polishing amount of the raw wafer can be reduced to improve the flatness of the semiconductor wafer by simultaneously polishing the both surfaces of the raw wafer after the completion of the grinding step with the same polishing cloth at one-time polishing step from rough polishing to finish polishing while supplying at least two polishing solutions classified by an average particle size of abrasives to be included into a polishing cloth containing no abrasive so as to change from a polishing solution containing larger size of abrasives to a polishing solution containing smaller size of abrasives in stages.

The invention is based on the above knowledge, and the summary and construction thereof are as follows. 1. A semiconductor wafer having a diameter of not less than 450 mm and being finish-polished on its both surfaces.

2. A semiconductor wafer according to the item 1, wherein a flatness (GBIR) is not more than 0.1 μm.

3. A method of producing a semiconductor wafer, which comprises a polishing step for finish-polishing both surfaces of a raw wafer while supplying a polishing solution containing abrasives to a polishing cloth, wherein at least two polishing solutions classified by an average particle size of abrasives to be included are supplied into the polishing cloth while changing from a polishing solution containing larger size of abrasives to a polishing solution containing smaller size of abrasives in stages, whereby the polishing step from rough polishing to finish polishing is conducted on both surfaces of the raw wafer simultaneously with the same polishing cloth.

4. The method of producing a semiconductor wafer according to the item 3, wherein the at least two polishing solutions are a polishing solution containing rough polishing abrasives and a polishing solution containing finish polishing abrasives.

5. The method of producing a semiconductor wafer according to the item 4, wherein the rough polishing abrasives have an average particle size of more than 0.5 μm but not more than 2.0 μm.

6. The method of producing a semiconductor wafer according to the item 4 or 5, wherein the finish polishing abrasives have an average particle size of 0 to 0.5 μm (not including 0 μm).

7. The method of producing a semiconductor wafer according to any one of the items 4 to 6, wherein the rough polishing abrasives are colloidal silica.

8. The method of producing a semiconductor wafer according to any one of the items 4 to 7, wherein the finish polishing abrasives are colloidal silica.

9. The method of producing a semiconductor wafer according to any one of the items 3 to 8, wherein the semiconductor wafer is a large-size silicon wafer having a diameter of not less than 450 mm.

In the method of producing a semiconductor wafer according to the invention, the polishing step from rough polishing to finish polishing is conducted with the same polishing cloth, whereby the polishing amount of the raw wafer can be reduced to obtain a semiconductor wafer having an excellent flatness.

Also, it is possible to reduce the number of polishing steps by consolidating the whole of the polishing steps from a rough polishing step to a finish polishing step to one step.

In particular, the method of producing a semiconductor wafer according to the invention is suitable for obtaining a large-size semiconductor wafer having a diameter of not less than 450 mm, especially a silicon wafer.

### BRIEF DESCRIPTION OF THE DRAWING

The invention will be described with reference to the accompanying drawings, wherein:

FIG. 1 is a perspective view showing an example of a double-side polishing apparatus used in the production method according to the invention;

FIG. 2 is a plan view of the double-side polishing apparatus shown in FIG. 1 viewed from directly above at a state of removing an upper platen; and

FIG. 3 is a cross-sectional view of the double-side polishing apparatus shown in FIG. 1 at a state of polishing a raw wafer taken along lines I-I of FIG. 2.

### DESCRIPTION OF REFERENCE SYMBOLS

1 upper platen
2 lower platen
3 upper polishing cloth
4 lower polishing cloth
5, 5a, 5b, 5c small holes
6 carrier
7 center gear
8 pipe for supplying a polishing solution
9 raw wafer
100 double-side polishing apparatus

### DESCRIPTION OF THE PREFERRED EMBODIMENTS

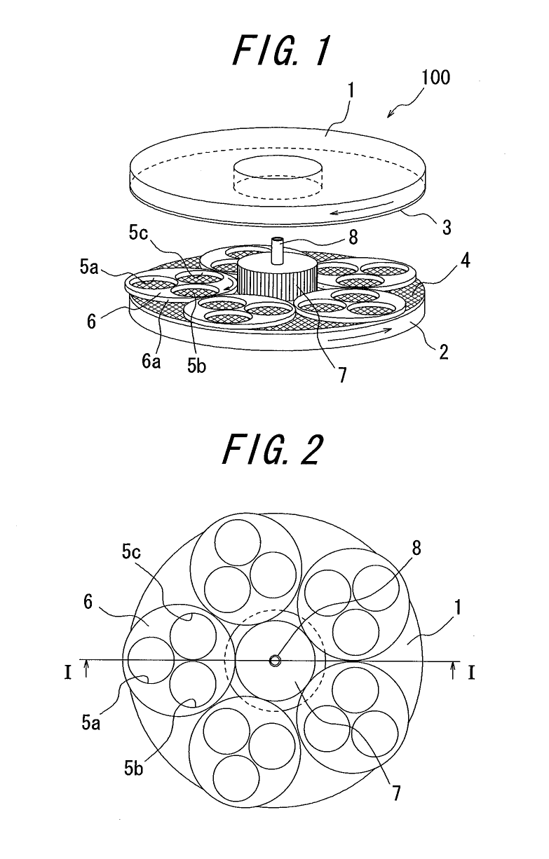

FIG. 1 is a perspective view showing an example of a double-side polishing apparatus used in the production method of the invention. The double-side polishing apparatus 100 comprises a pair of an upper platen 1 and a lower platen 2, an upper polishing cloth 3 and a lower polishing cloth 4 fixed to the respective upper platen 1 and lower platen 2, carriers 6 each having small holes 5 and a side face gear 6a, a center gear 7 engaging with the side face gears 6a of the carriers 6 and a pipe 8 for supplying a polishing solution.

FIG. 2 is a plan view of the double-side polishing apparatus 100 of FIG. 1 viewed from directly above at a state of removing the upper platen 1. Although the double-side polishing apparatus 100 is an example of having five carriers 6, the invention is sufficient to comprise at least one carrier 6, and the number of the carriers can be increased or decreased, if necessary.

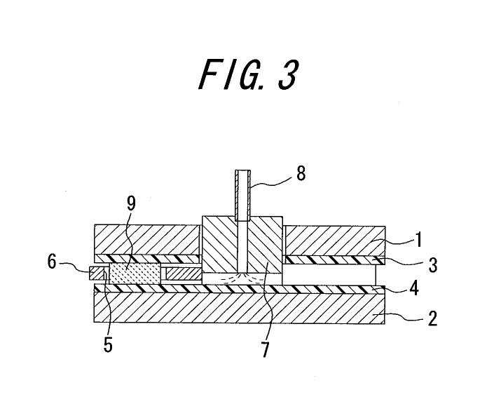

FIG. 3 is a cross-sectional view of the double-side polishing apparatus 100 taken along line I-I shown in FIG. 2 at a state of polishing a raw wafer 9.

The raw wafer 9 fitted into the small hole 5a of the carrier 6 is sandwiched between the upper platen 1 fixed with the upper polishing cloth 3 and the lower platen 2 fixed with the lower polishing cloth 4, and then the upper platen 1 and the lower platen 2 are rotated in directions opposed to each other as shown in FIG. 2 while supplying a polishing solution to the upper polishing cloth 3 and the lower polishing cloth 4 from the pipe 8 for supplying the polishing solution, and the carrier 6 is rotated in an arrow direction with the center gear 7, whereby the both surfaces of the raw wafer 9 are simultaneously polished.

In the invention, the raw wafer 9 ground with abrasives of about #2000 is fitted into the small hole 5a of the carrier 6 for polishing. The whole of the polishing step from rough polishing to finish polishing can be conducted on both surfaces of the raw wafer simultaneously with the same polishing cloth at one step while sandwiching the raw wafer 9 between the upper platen 1 and the lower platen 2 by supplying at least two kinds of polishing solutions classified by an average particle size of abrasives to be included while changing from a polishing solution containing larger size of abrasives to a polishing solution containing smaller size of abrasives in stages. Therefore, there is no formation of flaw nor attachment of contaminant to the raw wafer on the way of the polishing different from such a conventional method that the polishing cloth is exchanged for changing the polishing solution into a polishing solution containing different size of abrasives to be included between the rough polishing step and the finish polishing step or the raw wafer is handled when the raw wafer on the way of the polishing is transferred to another double-side polishing apparatus. Thus, it is not required to increase the finish polishing amount for removing flaws or contaminants from the raw wafer on the way of the polishing, and hence the total polishing amount of the raw wafer can be reduced. As a result, it is possible to improve the flatness of the semiconductor wafer. In addition to the improvement of the flatness of the semiconductor wafer by the reduction of the total polishing amount of the raw wafer, the method of producing a semiconductor wafer according to the invention does not require the application of strain or the like to the raw wafer due to the handling of the raw wafer as in the conventional method, which also contributes to improve the flatness of the semiconductor wafer. Moreover, it is possible to reduce the number of polishing steps by consolidating steps from rough polishing step to finish polishing step into one step.

Next, the polishing cloth and abrasives used in the production method of the invention will be explained.

The upper polishing cloth 3 and the lower polishing cloth 4 do not contain abrasives and are not particularly limited as long as they are not broken when the raw wafer 9 is rotated while being sandwiched between the upper platen 1 and the lower platen 2. They are preferable to be a urethane. Moreover, the upper polishing cloth 3 and the lower polishing cloth 4 may be made of the same material or different materials.

The rough polishing abrasives are preferable to have an average particle size of more than 0.5 μm but not more than 2.0 μm. When the average particle size of the rough polishing abrasives is not more than 0.5 μm, there is a fear of lowering the polishing rate. While, when it exceeds 2.0 μm, there is a fear of forming flaws in the surface of the raw wafer on the way of the polishing. More preferably, the average particle size of the rough polishing abrasives is a range of 0.8 to 1.5 μm.

As the rough polishing abrasives, there are provided more than two kinds of rough polishing abrasives having a size within the above range, from which polishing solutions containing the respective rough polishing abrasives are formed and thereafter polishing may be conducted while changing from a polishing solution containing larger size of abrasives to a polishing solution containing smaller size of abrasives in stages. For example, a first rough polishing conducted while supplying a polishing solution containing first rough polishing abrasives having an average diameter of 1.5 μm to a polishing cloth and a second rough polishing conducted while supplying a polishing solution containing second rough polishing abrasives having an average diameter of 1.0 μm to a polishing cloth may be conducted with the same polishing cloth in the order of the first rough polishing→the second rough polishing. The raw wafer can be polished with a polishing solution containing abrasives always optimized to a surface state of the raw wafer changed with the advance of the polishing when the number of changes from a polishing solution containing larger size of abrasives to a polishing solution containing smaller size of abrasives becomes large. In the conventional method, it is necessary to conduct the exchange of the polishing cloth or the like every change into a polishing solution containing different size of abrasives, whereas in the production method of the invention, the polishing can be conducted with the same polishing cloth, which reduces the number of steps or prevents the formation of flaws in the semiconductor wafer on the way of the polishing.

The finish polishing abrasives are preferable to have an average particle size of 0 to 0.5 μm (not including 0 μm). When the average particle size of the finish polishing abrasives exceeds 0.5 μm, there is a fear of forming flaws in the surface of the raw wafer on the way of the polishing. More preferably, the average particle size of the finish polishing abrasives is a range of 0.1 to 0.2 μm.

As the finish polishing abrasives, there are also provided more than two kinds of finish polishing abrasives having a size within the above range likewise the case of the rough polishing abrasives, from which polishing solutions containing the respective size of the finish polishing abrasives are formed, whereby the polishing may be conducted.

Next, the polishing conditions in the production method of the invention will be explained.

A polishing solution is formed by mixing the above abrasives with an alkali solution and supplied to the upper polishing cloth 3 and the lower polishing cloth 4 through the pipe 8 for supplying the polishing solution. The amount of the polishing solution supplied changes depending on the revolution number of each of the upper platen 1, the lower platen 2 and the carrier 6 and the force of sandwiching the raw wafer 9 between the upper platen 1 and the lower platen 2. However, each condition may be set so that a polishing solution film having a thickness of not less than a certain value can be formed between the upper polishing cloth 3 or the lower polishing cloth 4 and the surface of the raw wafer 9 during the polishing to smoothly conduct the polishing. The range of each condition capable of forming the polishing solution film having a thickness of not less than a certain value to smoothly conduct the polishing is as follows. Moreover, the value in parentheses is a preferable condition range.

Amount of polishing solution supplied: 0 to 2000 ml/min (not including 0 ml/min) (preferably 500 to 1000 ml/min)
Revolution number of upper platen 1:0 to 80 rpm (not including 0 rpm) (preferably 10 to 50 rpm)
Revolution number of lower platen 2:0 to 80 rpm (not including 0 rpm) (preferably 10 to 50 rpm)
Revolution number of carrier 6:0 to 80 rpm (not including 0 rpm) (preferably 5 to 50 rpm)

The polished amount of the raw wafer rough-polished under the above conditions (total amount of both surfaces polished) is preferable to be 0 to 20 μm (not including 0 μm). More preferably, it is a range of 5 to 12 μm. Moreover, the polished amount of the raw wafer finish-polished (total amount of both surfaces polished) is preferable to be 0 to 1 μm (not including 0 μm). More preferably, it is a range of 0.1 to 0.8 μm.

According to the above production method of the invention, it is possible to produce a semiconductor wafer having a diameter of not less than 450 mm and being finish-polished on its both surfaces.

Particularly, the semiconductor wafer having a diameter of not less than 450 mm and being finish-polished on its both surfaces, which is obtained by the production method of the invention, has an excellent flatness (GBIR) of not more than 0.1 μm.

Although the above is described with respect to only one embodiment of the invention, various modifications may be made without departing from the scope of the appended claims.

A sample semiconductor wafer is prepared by the production method according to the invention, which will be described below.

### INVENTION EXAMPLE 1

Both surfaces of a raw wafer ground on its both surfaces with abrasives of #1000 are simultaneously polished at a polishing step from rough polishing to finish polishing with the same polishing cloth using a double-side polishing apparatus. 100 shown in FIG. 1 by the method of producing a semiconductor wafer according to the invention to prepare 50 sample silicon wafers having a diameter of 300 mm. The polishing conditions are as follows.

Upper polishing cloth 3: urethane series, Lower polishing cloth 4: urethane series
Rough polishing abrasives: colloidal silica, average particle size: 1.5 μm
Finish polishing abrasive: colloidal silica, average particle size: 0.2 μm
Amount of polishing solution supplied: 500 ml/min
Revolution number of upper platen 1:30 rpm
Revolution number of lower platen 2:30 rpm
Revolution number of carrier 6:15 rpm
Rough polished amount (total amount of both surfaces): 20 μm
Finish polished amount (total amount of both surfaces): 0.5 μm

### Comparative Example 1

50 sample silicon wafers having a diameter of 300 mm are prepared by the same production method as in Invention Example 1 except that the double-side polishing apparatus 100 is stopped once after the polishing with the polishing solution containing rough polishing abrasives and the upper polishing cloth 3 and the lower polishing cloth 4 are exchanged and then the polishing is conducted with a polishing solution containing finish polishing abrasives.

### Comparative Example 2

50 sample silicon wafers having a diameter of 300 mm are prepared by the same production method as in Comparative Example 1 except that the finish polished amount is 1.0 μm.

### INVENTION EXAMPLE 2

50 sample silicon wafers having a diameter of 300 mm are prepared by the same production method as in Invention Example 1 except that first rough polishing abrasives and second rough polishing abrasives are used as the rough polishing abrasives and first finish polishing abrasives and second finish polishing abrasives are used as the finish polishing abrasives. Moreover, polishing conditions different from

Invention Example 1 are as follows.
Upper polishing cloth 3: urethane series, Lower polishing cloth 4: urethane series
First rough polishing abrasives: colloidal silica, average particle size: 1.5 μm
Second rough polishing abrasives: colloidal silica, average particle size: 1.0 μm
First finish polishing abrasives: colloidal silica, average particle size: 0.5 μm
Second finish polishing abrasives: colloidal silica, average particle size: 0.25 μm
First rough polished amount: 15 μm
Second rough polished amount: 5 μm
First finish polished amount: 0.4 μm
Second finish polished amount: 0.1 μm

### Comparative Example 3

50 sample silicon wafers having a diameter of 300 mm are prepared by the same production method as in Invention Example 2 except that the double-side polishing apparatus 100 is stopped once every the change of abrasives and the upper polishing cloth 3 and the lower polishing cloth 4 are exchanged to conduct the polishing.

### INVENTION EXAMPLE 3

Both surfaces of a raw wafer ground on its both surfaces with abrasives of #1000 are simultaneously polished at a polishing step from rough polishing to finish polishing with the same polishing cloth using a double-side polishing apparatus 100 shown in FIG. 1 by the method of producing a semiconductor wafer according to the invention to prepare 50 sample silicon wafers having a diameter of 450 mm. The polishing conditions are as follows.

Upper polishing cloth 3: urethane series, Lower polishing cloth 4: urethane series
Rough polishing abrasives: colloidal silica, average particle size: 1.5 μm
Finish polishing abrasives: colloidal silica, average particle size: 0.2 μm
Amount of polishing solution supplied: 500 ml/min
Revolution number of upper platen 1:30 rpm
Revolution number of lower platen 2:30 rpm
Revolution number of carrier 6:15 rpm
Rough polished amount (total amount of both surfaces): 20 μm
Finish polished amount (total amount of both surfaces): 0.5 μm

### Comparative Example 4

50 sample silicon wafers having a diameter of 450 mm are prepared by the same production method as in Invention Example 3 except that the double-side polishing apparatus 100 is stopped once after the polishing with the polishing solution containing rough polishing abrasives and the upper polishing cloth 3 and the lower polishing cloth 4 are exchanged and then the polishing is conducted with a polishing solution containing finish polishing abrasives.

### Comparative Example 5

50 sample silicon wafers having a diameter of 450 mm are prepared by the same production method as in Comparative Example 4 except that the finish polished amount is 1.0 μm.

### INVENTION EXAMPLE 4

50 sample silicon wafers having a diameter of 450 mm are prepared by the same production method as in Invention Example 3 except that first rough polishing abrasives and second rough polishing abrasives are used as the rough polishing abrasives and first finish polishing abrasives and second finish polishing abrasives are used as the finish polishing abrasives. Moreover, polishing conditions different from Invention Example 3 are as follows.

Upper polishing cloth 3: urethane series, Lower polishing cloth 4: urethane series
First rough polishing abrasives: colloidal silica, average particle size: 1.5 μm
Second rough polishing abrasives: colloidal silica, average particle size: 1.0 μm
First finish polishing abrasives: colloidal silica, average particle size: 0.5 μm
Second finish polishing abrasives: colloidal silica, average particle size: 0.25 μm
First rough polished amount: 15 μm
Second rough polished amount: 5 μm
First finish polished amount: 0.4 μm
Second finish polished amount: 0.1 μm

### Comparative Example 6

50 sample silicon wafers having a diameter of 450 mm are prepared by the same production method as in Invention Example 4 except that the double-side polishing apparatus 100 is stopped once every the change of abrasives and the upper polishing cloth 3 and the lower polishing cloth 4 are exchanged to conduct the polishing.

With respect to each sample thus obtained are evaluated scratches and contaminant on the surface and flatness (GBIR). The evaluation methods will be described below.

### (Scratches and Contaminant on Surface)

The surface of each sample is observed with a surface defect examining apparatus (SP1) using a semiconductor laser to measure the number of scratches and contaminants on the surface, and each sample is evaluated as follows. Acceptable: the number of scratches and contaminants on the sample surface is 0 Unacceptable: the number of scratches and contaminant on the sample surface is 1 or more

From the evaluation results on acceptance or unacceptance of each sample is calculated an acceptance ratio with respect to the scratches and contaminants on the surface for each 50 wafers in Examples 1 to 4 and Comparative Examples 1 to 6.

### (Flatness (GBIR))

The flatness (GBIR) of each sample is measured with an electrostatic capacitance type flatness measuring apparatus. From the measured results for each sample is calculated an average value among 50 wafers in each of Examples 1 to 4 and Comparative Examples 1 to 6.

The evaluation results are shown in Table 1.

TABLE 1

| | | Polished amount (μm) | | | | | Acceptance ratio | Average |
|---|---|---|---|---|---|---|---|---|
| | | Rough polished | | Finish polished | | | with respect to | value of |
| | Diameter of | amount | | amount | | | scratches and | flatness |
| Sample | silicon wafer | First rough | Second rough | First finish | Second finish | Total polished | contaminants on | (GBIR) |
| number | (mm) | polished amount | polished amount | polished amount | polished amount | amount | surface (%) | (μm) |
| Invention | 300 | 20 | | 0.5 | | 20.5 | 97 | 0.05 |
| Example 1 | | | | | | | | |
| Comparative | 300 | 20 | | 0.5 | | 20.5 | 95 | 0.15 |
| Example 1 | | | | | | | | |
| Comparative | 300 | 20 | | 1.0 | | 21.0 | 97 | 0.30 |
| Example 2 | | | | | | | | |
| Invention | 300 | 15 | 5 | 0.4 | 0.1 | 20.5 | 99 | 0.05 |
| Example 2 | | | | | | | | |
| Comparative | 300 | 15 | 5 | 0.4 | 0.1 | 20.5 | 93 | 0.17 |
| Example 3 | | | | | | | | |
| Invention | 450 | 20 | | 0.5 | | 20.5 | 97 | 0.05 |
| Example 3 | | | | | | | | |
| Comparative | 450 | 20 | | 0.5 | | 20.5 | 95 | 0.15 |
| Example 4 | | | | | | | | |
| Comparative | 450 | 20 | | 1.0 | | 21.0 | 97 | 0.35 |
| Example 5 | | | | | | | | |
| Invention | 450 | 15 | 5 | 0.4 | 0.1 | 20.5 | 99 | 0.05 |
| Example 4 | | | | | | | | |
| Comparative | 450 | 15 | 5 | 0.4 | 0.1 | 20.5 | 92 | 0.22 |
| Example 6 | | | | | | | | |

As obvious from the table, Invention Example 1 is good in both the acceptance ratio with respect to scratches and contaminants on the surface and the average value of the flatness (GBIR) though the finish polished amount is small. This is considered due to the fact that since the raw wafer on the way of the polishing is not handled in Invention Example 1, the scratches or contaminants and strain are hardly introduced into the raw wafer.

Also, Invention Example 2 is the same total polished amount as Invention Example 1, and hence the average value of the flatness (GBIR) is the same as in Invention Example 1, but the acceptance ratio with respect to scratches and contaminants on the surface is further improved. This is considered due to the fact that by providing two kinds of each of the rough polishing abrasives and finish polishing abrasives can be conducted the polishing with abrasives always optimized to the surface state of the raw wafer changed with the advance of the polishing.

On the other hand, Comparative Example 1 is low in the acceptance ratio with respect to scratches and contaminants on the surface though the finish polished amount is the same as in Invention Example 1. The average value of the flatness (GBIR) is also inferior as compared with Invention Example 1. This is considered due to the fact that by handling the raw wafer in the change of the polishing solution is formed scratches or contaminants on the raw wafer, whereby the acceptance ratio with respect to scratches and contaminants on the surface is lowered and also strains are introduced into the raw wafer to deteriorate the flatness (GBIR) of the semiconductor wafer. In Comparative Example 2, the finish polished amount is large, so that the average value of the flatness (GBIR) is inferior though the acceptance ratio with respect to scratches and contaminants on the surface is equivalent to that of Invention Example 1. This is considered due to the fact that by increasing the finish polished amount can be removed the surface scratches or contaminants generated through the handling of the raw wafer, but the flatness (GBIR) is deteriorated by the increase of the finish polished amount. In Comparative Example 3, the total polished amount is the same as in Invention Example 2, but the acceptance ratio with respect to scratches and contaminants on the surface is lowest among silicon wafers having a diameter of 300 mm and also the average value of the flatness (GBIR) is inferior. This is considered due to the fact that the handling number of the raw wafer in the change of the polishing solution is more than that in Invention Example 1, Invention Example 2, Comparative Example 1 and Comparative Example 2, and thus the scratches, contaminants or strains are easily introduced into the raw wafer.

Although the diameter of the silicon wafer in Invention Example 3 and Invention Example 4 is as large as 450 mm, the acceptance ratio with respect to scratches and contaminants on the surface and the average value of the flatness (GBIR) are the same as in Invention Example 1 and Invention Example 2 in which the diameter of the silicon wafer is 300 mm.

On the other hand, in Comparative Example 5 and Comparative Example 6 wherein the diameter of the silicon wafer is made as large as 450 mm, the acceptance ratio with respect to scratches and contaminants on the surface or the average value of the flatness (GBIR) is further deteriorated as compared with the case that the diameter of the silicon wafer is 300 mm. This is considered due to the fact that the increase in the diameter of the silicon wafer makes handling of the raw wafer difficult and thus the scratches, contaminants or strains are easily introduced into the raw wafer during the handling.

In the method of producing a semiconductor wafer according to the invention, the polishing step from rough polishing to finish polishing is conducted with the same polishing cloth, whereby the polishing amount of the raw wafer can be reduced to obtain a semiconductor wafer having an excellent flatness.

Also, it is possible to reduce the number of polishing steps by consolidating the whole of the polishing steps from a rough polishing step to a finish polishing step to one step.

In particular, the method of producing a semiconductor wafer according to the invention is suitable for obtaining a large-size semiconductor wafer having a diameter of not less than 450 mm, especially a silicon wafer.

1. A semiconductor wafer having a diameter of not less than 450 mm and being finish-polished on its both surfaces.

2. A semiconductor wafer according to claim 1, wherein a flatness (GBIR) is not more than 0.1 μm.

3. A method of producing a semiconductor wafer, which comprises a polishing step for finish-polishing both surfaces of a raw wafer while supplying a polishing solution containing abrasives to a polishing cloth, wherein
at least two polishing solutions classified by an average particle size of abrasives to be included are supplied into the polishing cloth while changing from a polishing solution containing larger size of abrasives to a polishing solution containing smaller size of abrasives in stages, whereby the polishing step from rough polishing to finish polishing is conducted on both surfaces of the raw wafer simultaneously with the same polishing cloth.

4. The method of producing a semiconductor wafer according to claim 3, wherein the at least two polishing solutions are a polishing solution containing rough polishing abrasives and a polishing solution containing finish polishing abrasives.

5. The method of producing a semiconductor wafer according to claim 4, wherein the rough polishing abrasives have an average particle size of more than 0.5 μm but not more than 2.0 μm.

6. The method of producing a semiconductor wafer according to claim 4, wherein the finish polishing abrasives have an average particle size of 0 to 0.5 μm (not including 0 μm).

7. The method of producing a semiconductor wafer according to claim 4, wherein the rough polishing abrasives are colloidal silica.

8. The method of producing a semiconductor wafer according to claim 4, wherein the finish polishing abrasives are colloidal silica.

9. The method of producing a semiconductor wafer according to claim 3, wherein the semiconductor wafer is a large-size silicon wafer having a diameter of not less than 450 mm.

10. The method of producing a semiconductor wafer according to claim 5, wherein the finish polishing abrasives have an average particle size of 0 to 0.5 μm (not including 0 μm).

11. The method of producing a semiconductor wafer according to claim 5, wherein the rough polishing abrasives are colloidal silica.

12. The method of producing a semiconductor wafer according to claim 6, wherein the rough polishing abrasives are colloidal silica.

13. The method of producing a semiconductor wafer according claim 5, wherein the finish polishing abrasives are colloidal silica.

14. The method of producing a semiconductor wafer according claim 6, wherein the finish polishing abrasives are colloidal silica.

15. The method of producing a semiconductor wafer according claim 7, wherein the finish polishing abrasives are colloidal silica.

16. The method of producing a semiconductor wafer according to claim 4, wherein the semiconductor wafer is a large-size silicon wafer having a diameter of not less than 450 mm.

17. The method of producing a semiconductor wafer according to claim 5, wherein the semiconductor wafer is a large-size silicon wafer having a diameter of not less than 450 mm.

18. The method of producing a semiconductor wafer according to claim 6, wherein the semiconductor wafer is a large-size silicon wafer having a diameter of not less than 450 mm.

19. The method of producing a semiconductor wafer according to claim 7, wherein the semiconductor wafer is a large-size silicon wafer having a diameter of not less than 450 mm.

20. The method of producing a semiconductor wafer according to claim 8, wherein the semiconductor wafer is a large-size silicon wafer having a diameter of not less than 450 mm.
